(19) United States
(12) Patent Application Publication
(10) Pub. No.: US 2016/0063021 A1
(43) Pub. Date: Mar. 3, 2016

(54) Metadata Index Search in a File System

(71) Applicant: Futurewei Technologies, Inc., Plano, TX (US)

(72) Inventors: Stephen Morgan, San Jose, CA (US); Masood Mortazavi, Santa Clara, CA (US); Gopinath Palani, Sunnyvale, CA (US); Guangyu Shi, Cupertino, CA (US)

(21) Appl. No.: 14/831,292

(22) Filed: Aug. 20, 2015

Related U.S. Application Data
(60) Provisional application No. 62/043,257, filed on Aug. 28, 2014.

(51) Int. Cl. G06F 17/30

(52) U.S. Cl. CPC G06F 17/30109; G06F 17/30867; G06F 17/30097; G06F 17/30138; G06F 17/30194; G06F 17/30595

(57) ABSTRACT

An apparatus comprising an input/output (IO) port configured to couple to a large-scale storage device, a memory configured to store a plurality metadata databases (DBs) for a file system of the large-scale storage device, wherein the plurality of metadata DBs comprise key-value pairs with empty values, and a processor coupled to the IO port and the memory, wherein the processor is configured to partition the file system into a plurality of partitions by grouping directories in the file system by a temporal order, and index the file system by storing metadata of different partitions as keys in separate metadata DBs.

### CROSS-REFERENCE TO RELATED APPLICATIONS

The present application claims priority to U.S. Provisional Patent Application 62/043,257, filed Aug. 28, 2014 by Stephen Morgan, et. al., and entitled “SYSTEM AND METHOD FOR METADATA INDEX SEARCH IN A FILE SYSTEM”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In computing, file systems are methods and data structures for organizing and storing files on hard drives, flash drives, or any other storage devices. A file system separates data on a storage device into individual pieces, which are referred to as files. In addition, a file system may store data about files, for example, filenames, permissions, creation time, modification time, and other attributes. A file system may further provide indexing mechanisms so that users may access files stored in a storage device. For example, a file system may be organized into multiple levels of directories, which are containers for file system objects such as files and/or sub-directories. To reach a particular file system object in a file system, a path may be employed to specify a file system object storage location in the file system. A path comprises a string of characters indicating directories, sub-directories, and/or a file name. There are many different types of file systems. Different types of file systems may have different structures, logics, speeds, flexibilities, securities, and/or sizes.

### SUMMARY

In one embodiment, the disclosure includes an apparatus comprising an input/output (IO) port configured to couple to a large-scale storage device, a memory configured to store a plurality of metadata databases (DBs) for a file system of the large-scale storage device, wherein the plurality of metadata DBs comprise key-value pairs with empty values, and a processor coupled to the IO port and the memory, wherein the processor is configured to partition the file system into a plurality of partitions by grouping directories in the file system by a temporal order, and index the file system by storing metadata of different partitions as keys in separate metadata DBs.

In another embodiment, the disclosure includes an apparatus comprising an IO port configured to couple to a large-scale storage device, a memory configured to store a relational DB comprising metadata indexing information of a portion of a file system of the large-scale storage device, and a bloom filter comprising representations of at least a portion of the metadata indexing information, and a processor coupled to the IO port and the memory, wherein the processor is configured to receive a query for a file system object, and apply the bloom filter to the query to determine whether to search the relational DB for the queried file system object.

In yet another embodiment, the disclosure includes a method for searching a large-scale storage file system, comprising receiving a query for a file system object, wherein the query comprises at least a portion of a pathname of the queried file system object, applying a bloom filter to the portion of the pathname of the queried file system object, wherein the bloom filter comprises representations of pathnames in a particular portion of the large-scale storage file system, searching for the queried file system object in a relational DB comprising metadata indexing information of the particular file system portion when the bloom filter returns a positive result, and skipping search for the queried file system object in the relational DB when the bloom filter returns a negative result.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a file storage system.

FIG. 2 is a schematic diagram of an embodiment of a network element (NE) acting as a node in a network.

FIG. 3 is a schematic diagram of an embodiment of a file system sub-tree.

FIG. 4 is a schematic diagram of an embodiment of a hash table generation scheme.

FIG. 5 is a flowchart of an embodiment of a hash table generation method.

FIG. 6 is a schematic diagram of an embodiment of a bloom filter generation scheme.

FIG. 7 is a schematic diagram of an embodiment of a metadata index search query scheme.

FIG. 8 is a flowchart of an embodiment of a metadata index search query method.

FIG. 9 is a schematic diagram of an embodiment of a Log-Structured Merge (LSM) tree storage scheme.

FIG. 10 is a flowchart of an embodiment of a file system metadata update method.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

As file systems reach billions of files, millions of directories, and petabytes of data, it is becoming increasingly difficult for users to organize, find, and manage their files. Although hierarchical naming schemes may ease file management and may decrease file name collisions by employing multiple levels of directories and naming conventions, the benefits of the hierarchical naming schemes are limited in large-scale file systems. In large-scale file systems, metadata-based search schemes may be more practical and informative for file management and analysis. File system metadata refers to any data and/or information related to files. Some examples of metadata may include file types (e.g., a text document type and an application type), file characteristics (e.g., audio and video), file extensions (e.g., .doc for documents and .exe for executables), owners, groups, creation dates, change dates, link counts, and sizes. However, metadata-based searches in a large-scale file system with billions of tiles may be slow.

Disclosed herein are various embodiments of an efficient file metadata index search scheme for large-scale file systems. The file metadata index search scheme employs an indexing engine to maintain metadata for a file system in a plurality of metadata databases (DBs) and a search engine to search for file system objects based on user's file system metadata queries. The indexing engine divides a file system into a plurality of partitions by hashing on directories based on a temporal order of locality. For example, a large-scale file system may be partitioned into partitions of about 20 thousand (K) directories and/or about 1 million files. Indexing may be performed by crawling or scanning the directories of a file system. An initial crawl may be performed by an order of pathnames (e.g., depth-first search). Subsequent crawls or ongoing crawls may be performed by an order of change times. Thus, the partitions are organized based on crawl times or change times. Metadata DBs are generated during the initial crawl and updated during subsequent crawls. Metadata for different partitions are stored in different metadata DBs. In addition, different types of metadata (e.g., pathnames, number of links, file properties, custom tags) are stored in different metadata DBs. Thus, multiple metadata DBs may be related by associating with the same set of file system objects, where the multiple metadata DBs may be referred to as a relational DB. The metadata DBs are implemented by employing a key-value pair store model, but with empty values. The employment of empty-valued key-value pairs enables a more efficient usage of memory and allows for a faster search. In an embodiment, the metadata DBs store key-value records by employing an LSM tree technique to enable efficient writes and/or updates. An example of an LSM-based DB is a levelDB. The search engine employs bloom filters to reduce a query's search space, for example, excluding partitions and/or metadata DBs that are irrelevant to a query. In an embodiment, different bloom filters are employed for different partitions. The bloom filters are generated after the partitions are created from the hashing of the directories during an initial crawl and updated after subsequent crawls. The bloom filters may operate on pathnames or any other types of metadata. Upon receiving a query, the search engine applies the bloom filters to the query to identify partitions that possibly carry data relevant to the query. When a bloom filter of a particular partition indicates a positive match for the query, the search engine further searches the metadata DBs associated with the particular partition. Since bloom filters may eliminate unnecessary searches about 90-95 percent (%) of the time, file metadata query time may be reduced significantly, for example, a query's search time may be in an order of seconds. Thus, the disclosed file metadata index search scheme allows fast and complex file metadata searches and may provide good scalability for employment in large-scale file systems. It should be noted that in the present disclosure, directory names and pathnames are equivalent and may be used interchangeably.

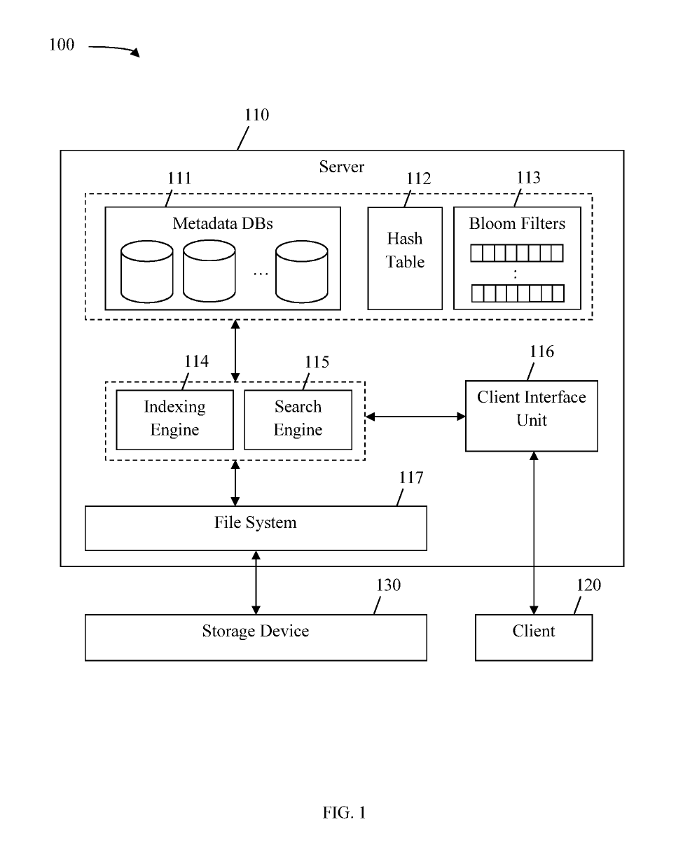

FIG. 1 is a schematic diagram of an embodiment of a file storage system 100. The system 100 comprises a server 110, a client 120, and a storage device 130. The server 110 is communicatively coupled to the storage device 130 and the client 120. The storage device 130 is any device suitable for storing data. For example, the storage device 130 may be a hard disk drive or a flash drive. In an embodiment, the storage device 130 may be a large-scale storage device and/or system that stores billions of files, millions of directories, and/or petabytes of data. Although the storage device 130 is illustrated as an external component of the server 110, the storage device 130 may be an internal component of the server 110. The server 110 manages the storage device 130 for file storage and access. The client 120 is a user or a user program that queries the server 110 for files stored in the storage device 130. In addition, the client 120 may add a file to the storage device 130, modify an existing file in the storage device 130, and/or delete a file from the storage device 130. In some embodiments, the client 120 may be coupled to the server 110 via a network, which may be any types of networks (e.g., an electrical network and/or an optical network).

The server 110 is a virtual machine (VM), a computing machine, a network server, or any device configured to manage file storage, file access, and/or file search on the storage device 130. The server 110 comprises a plurality of metadata DBs 111, a hash table 112, a plurality of bloom filters 113, an indexing engine 114, a search engine 115, a client interface unit 116, and a file system 117. The file system 117 is a software component communicatively coupled to the storage device 130, for example, via an input/output (IO) port interface, and configured to manage the naming and storage locations of files in the storage device 130. For example, the file system 117 may comprise multiple levels of directories and paths to the files stored on the storage device 130. The indexing engine 114 is a software component configured to manage indexing of the files stored on the storage device 130. The indexing engine 114 indexes files by metadata, which may include base names of the files, pathnames of the files, and/or any file system attributes, such as file types, file extensions, file sizes, file access times, file modification times, file change times, number of links associated with the files, user IDs, group IDs, and file permissions. For example, for a file data.c stored under a directory /a/b/c, the base name is data.c and the pathname is /a/b/c. In addition, the metadata may include custom attributes and/or tags, such as file characteristics (e.g., audio and video) and/or content-based information (e.g., Motion Picture Expert Group Layer 4 video (mpeg4)). Custom attributes are specific metadata customized for a file, for example, generated by a user or the client 120.

The indexing engine 114 provides flexibility and scalability by partitioning the file system 117 into a plurality of partitions, limiting the maximum size of a partition, and generating metadata indexes by partitions. For example, in a large-scale storage with about a billion files, the indexing engine 114 may divide the file system 117 into about 1000 partitions of about 1 million files or about 20 thousand (K) directories assuming an average of about 50 files per directory. By partitioning the file system 117 into multiple partitions, searches may be performed more efficiently, as described more fully below. The indexing engine 114 divides the file system 117 into partitions by applying a hash function on the directory names. For example, the indexing engine 114 may employ any hash scheme that provides a uniform random distribution, such as a BuzHash scheme that generates hash values by applying shift and exclusive-or functions to pseudo-random numbers. The indexing engine 114 performs partitioning and indexing based on a temporal order of locality. During an initial crawl or a first time crawl of the file system 117, the indexing engine 114 traverses or scans the file system 117 by an order of pathnames similar to a depth-first search technique. A depth-first search starts at a root of a directory tree, for example, by selecting a root node, and traverses along each branch as deep as possible before backtracking. Thus, by scanning and indexing in the order of pathnames, the partitioning during the initial crawl groups files and/or directories by scan times. During subsequent crawls, the file indexing engine 114 traverses the file system 117 by an order of change times, and thus files and/or directories by change times. The file indexing engine 114 generates an entry for each file system directory in the hash table 112. For example, the hash table 112 may comprise entries that map directory names and/or pathnames to hash codes corresponding to the partitions, as discussed more fully below.

After dividing the file system 117 into partitions, the indexing engine 114 generates bloom filters 113 for the partitions. For example, a bloom filter 113 is generated for each partition. The bloom filters 113 enable the search engine 115 to quickly identify partitions that possibly carry data relevant to a query, as discussed more fully below. The bloom filters 113 are bit vectors initially set to zeroes. An element may be added to a bloom filter 113 by applying k (e.g., k=4) hash functions to the element to generate k bit positions in the bit vector and setting the bits to ones. An element may be a directory name (e.g., /a/b/c) or a portions of the directory name (e.g., /a, /b, /c). Subsequently, the presence or membership of an element (e.g., directory name) in a set (e.g., partition) may be tested by hashing the element k times with the same hash functions to obtain k bit positions and checking corresponding bit values. If any of the bits comprises a value of zero, the element is definitely not a member of the set. Otherwise, the element is in the set or a false positive.

In addition to generating bloom filters 113, the indexing engine 114 generates metadata DBs 111 for storing metadata associated with the file system 117. The indexing engine 114 may generate the metadata as the directories are scanned. Thus, the file system 117 is indexed and the metadata DBs 111 are organized based on the same temporal order as the scanning of the directories, where the temporal order is based on scan times during an initial crawl and based on change times during subsequent crawls. In an embodiment, the indexing engine 114 examines each file in the file system 117 separately to generate metadata for the file, for example, by employing a Unix system call stat( ) to retrieve file attributes. The indexing engine 114 maps the metadata to index node (inode) numbers and device numbers. The device number identifies the file system 117. The inode number is unique within the file system 117 and identifies a file system object in the file system 117, where a file system object may be a file or a directory. For example, a file may be associated with multiple string names and/or paths, the file may be uniquely identified by a combination of inode number and device number. In some embodiments, the server 110 may comprise multiple file systems 117 corresponding to one or more storage devices 130. In such embodiments, the indexing engine 114 may partition each file system 117 separately and generate and maintain hash tables 112, metadata DBs 111, and bloom filters 113 separately for each file system 117.

As an example, different types of metadata for a file named, “/proj/a/b/c/data.c”, with inode number 12 and device number 2048 may be stored in different metadata DBs 111. For example, a pathname of the file may be stored in a first metadata DB 111, denoted as a PATH metadata DB. A number of links associated with the file may be stored in a second metadata DB 111, denoted as a LINK metadata DB. An inverted relationship between different names of the file and the inode number and the device number of the file may be stored in a third metadata DB 111, denoted as an INVP metadata DB. For example, a hard link may be created to associate the file with a different name, “/proj/data.c”. The custom metadata of the file may be stored in a fourth metadata DB 111, denoted as a CUSTOM metadata DB. For example, the file may be tagged with custom data (e.g., non-file system attribute), such as an mpeg-4 format. The metadata DBs 111 stores each entry in a key-value pair with empty values. The empty-valued configuration enables the metadata DBs 111 to be search quicker and may provide efficient storages. The following table shows examples of entries in the metadata DBs 111:

TABLE 1
Examples of Metadata DB 111 Entries

| Metadata DBs | Keys | Values |
|---|---|---|
| PATH metadata DB | “/proj/a/b/c/data.c:00002048:00000012” | Empty |
| LINK metadata DB | “02:00002048:00000012” | Empty |
| INVP metadata DB | “00002048:00000012:/proj/a/b/c/data.c” | Empty |
| | “00002048:00000012:/proj/data.c” | |
| CUSTOM metadata | “format:mpeg-4:00002048:00000012” | Empty |
| DB | | |

As shown, different fields or metadata in the keys are separated by delimiters (shown as colons). It should be noted that the delimiters may be any characters (e.g., a Unicode character) that are not employed for pathnames. The delimiters may be used by the search engine 115 to examine different metadata fields during searches. In addition to the example metadata DBs 111 described above, the indexing engine 114 may generate metadata DBs 111 for other types of metadata, such as file types, file sizes, file change times, etc. The group of metadata DBs 111 (e.g., a PATH metadata DB, a LINK metadata DB, and an INVP metadata DB) that store metadata indexes for the same file system objects may together form a relational DB, in which a well-defined relationship may be established among the group of metadata DBs 111. Alternatively, different types of metadata associated with the same file system objects may be stored as separate tables (e.g., a PATH table, a LINK table, and an INVP table) residing in a single metadata DB 111, which is a relational DB.

The indexing engine 114 may additionally aggregate all metadata of a file in a fifth metadata DB 111, denoted as MAIN metadata DB. However, the MAIN metadata DB comprises a non-empty value. Table 2 illustrates an example of a MAIN metadata DB entry for a file identified by inode number 12 and device number 2048. For example, the file is a regular file with permission 0644 (e.g., in octal format). The file is owned by a user identified by user identifier (ID) 100 and a group identified by group ID 101. The file contains 65,536 bytes and comprises an access time of 1000000001, a change time of 1000000002, and a modification time of 1000000003 seconds.

TABLE 2
An Example of a MAIN metadata DB Entry

| | |
|---|---|
| Key | “00002048:00000012” |
| Value | “R:0644:0000000001:0000000100:0000000101:0000065536: |
| | 1000000001:1000000002:1000000003” |

The client interface unit 116 is a software component configured to interface queries and query results between the client 120 and the search engine 115. For example, when the client interface unit 116 receives a file query from the client 120, the client interface unit 116 may parse and/or format the query so that the search engine 115 may operate on the query. When the client interface unit 116 receives a query result from the search engine 115, the client interface unit 116 may format the query result, for example, according to a server-client protocol and send the query result to the client 120.

The search engine 115 is a software component configured to receive queries from the client 120 via the client interface unit 116, determines partitions that comprise data relevant to the queries via the bloom filters 113, searches the metadata DBs 111 associated with the partitions, and sends query results to the client 120 via the client interface unit 116. In an embodiment, the bloom filters 113 operate on pathnames or directory names. Thus, a query for a file may include at least a portion of a pathname, as discussed more fully below. When the search engine 115 receives a query, the search engine 115 applies the bloom filters 113 to the query. As described above, the query may be hashed according to the bloom filters 113 hash functions. When a bloom filter 113 returns all ones for the hashed bit-positions, a partition corresponding to the bloom filter 113 may possibly carry data relevant to the query. Subsequently, the search engine 115 may further search the metadata DBs 111 associated with the corresponding partition.

Subsequently, when a file or a directory is changed in the file system 117, the indexing engine 114 may perform another crawl to update the hash table 112, the bloom filters 113, and the metadata DBs 111. In an embodiment, the metadata DBs 111 are implemented as levelDBs, which employ an LSM technique to provide efficient updates, as discussed more fully below. It should be noted that the system 100 may be configured as shown or alternatively configured as determined by a person of ordinary skill in the art to achieve similar functionalities.

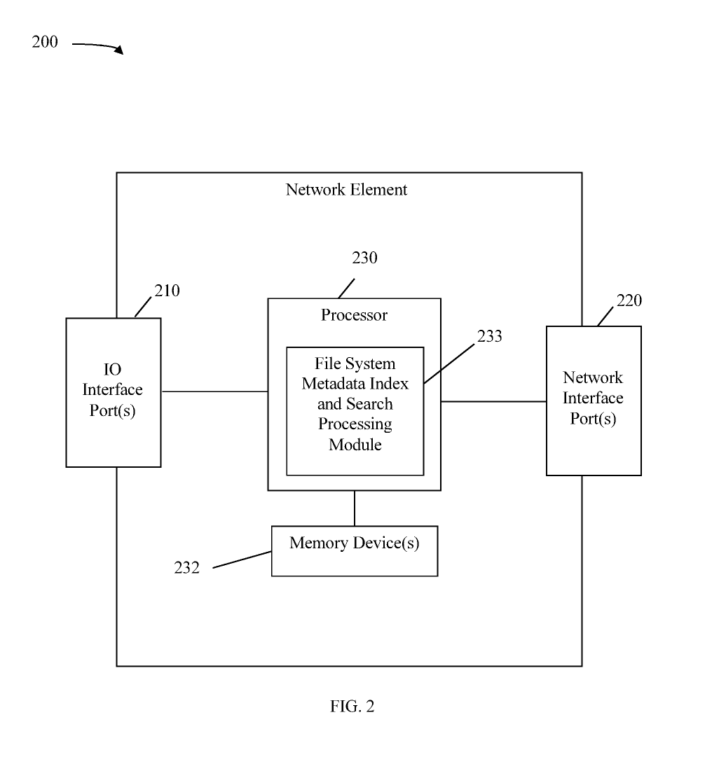

FIG. 2 is a schematic diagram of an example embodiment of an NE 200 acting as a node, such as a server 110, a client 120, and/or a storage device 130, in a file storage system, such as the system 100. NE 200 may be configured to implement and/or support the metadata indexing and/or search mechanisms described herein. NE 200 may be implemented in a single node or the functionality of NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments. At least some of the features and/or methods described in the disclosure may be implemented in a network apparatus or module such as an NE 200. For instance, the features and/or methods in the disclosure may be implemented using hardware, firmware, and/or software installed to run on hardware. As shown in FIG. 2, the NE 200 may comprise one or more IO interface ports 210, and one or more network interface ports 220. The processor 230 may comprise one or more multi-core processors and/or memory devices 232, which may function as data stores, buffers, etc. The processor 230 may be implemented as a general processor or may be part of one or more application specific integrated circuits (ASICs) and/or digital signal processors (DSPs). The processor 230 may comprise a file system metadata index and search processing module 233, which may perform processing functions of a server or a client and implement methods 500, 800, and 1000 and schemes 300, 400, 600, 700, and 900, as discussed more fully below, and/or any other method discussed herein. As such, the inclusion of the file system metadata index and search processing module 233 and associated methods and systems provide improvements to the functionality of the NE 200. Further, the file system metadata index and search processing module 233 effects a transformation of a particular article (e.g., the file system) to a different state. In an alternative embodiment, the file system metadata index and search processing module 233 may be implemented as instructions stored in the memory devices 232, which may be executed by the processor 230. The memory device 232 may comprise a cache for temporarily storing content, e.g., a random-access memory (RAM). Additionally, the memory device 232 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 232 may be configured to store metadata DBs, such as the metadata DBs 111, hash tables, such as the hash tables 112, and bloom filters, such as the bloom filters 113. The IO interface ports 210 may be coupled to IO devices, such as the storage device 130, and may comprise hardware logics and/or components configured to read data from the IO devices and/or write data to the IO devices. The network interface ports 220 may be coupled to a computer data network and may comprise hardware logics and/or components configured to receive data frames from other network nodes, such as the client 120, in the network and/or transmit data frames to the other network nodes.

It is understood that by programming and/or loading executable instructions onto the NE 200, at least one of the processor 230 and/or memory device 232 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

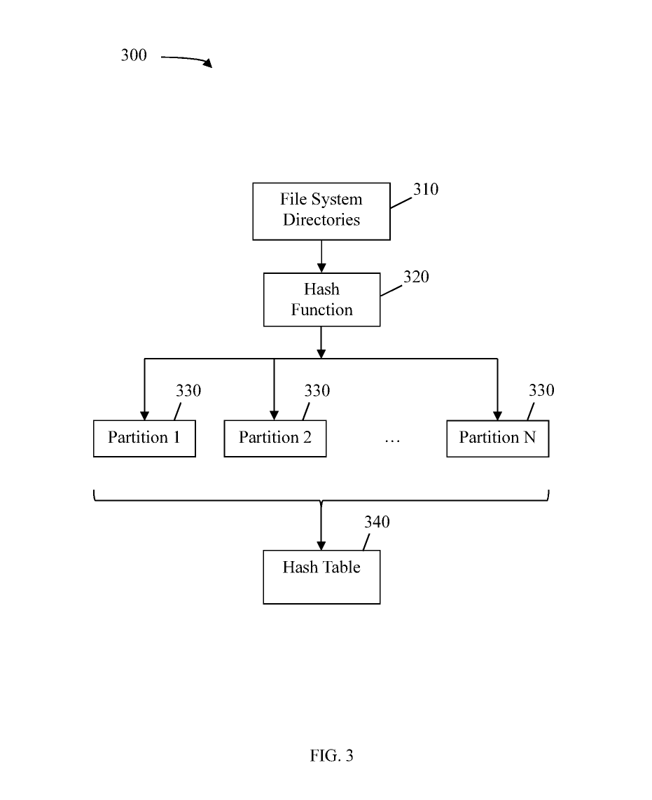

FIG. 3 is a schematic diagram of an embodiment of a file system partitioning scheme 300. The scheme 300 is employed by a file server indexing engine, such as the indexing engine 114 in the server 110, to divide a file system, such as the file system 117 into multiple partitions for indexing and search. The scheme 300 is executed when creating and/or updating file system objects. The scheme 300 mapped file system directories 310 to partitions 330 (e.g., Partition 1 to N) by employing a hash function 320. As shown, the scheme 300 begins with scanning (e.g., crawling) the file system directories 310 and applying a hash function 320 to each file system directory 310. For example, a depth-first search technique may be employed for scanning the file system directories 310, as discussed more fully below. The hash function 320 generates a hash value for each directory. The hash function 320 may be any types of hash function that produces a uniform random distribution. For example, the hash function 320 may be a BuzHash function that generates hash values by rotating and exclusive-ORing random numbers. The file system directories 310 that are hashed to a same value are grouped into the same partition 330, as discussed more fully below. In an embodiment, the scheme 300 divides a file system into partitions 330 of about 20K directories. The file system directories 330 or the directory names are stored in a hash table 340, such as the hash tables 112. For example, the file system directories 310 that are assigned to the same partition may be stored under a hash code corresponding to the partition 330. Subsequently, when a file system directory 310 is updated (e.g., adding and/or deleting files and/or sub-directories or relocating the directory), the scheme 300 may be applied to update the partitions 330. During a subsequent scan or crawl, the file system directories 310 are re-partitioned according to change times. Thus, the scheme 300 creates partitions 330 in a temporal order, which is based on scan times during initial creation and based on change times during subsequent updates. It should be noted that the sizes of the partitions 330 may be alternatively configured as determined by a person of ordinary skill in the art to achieve similar functionalities.

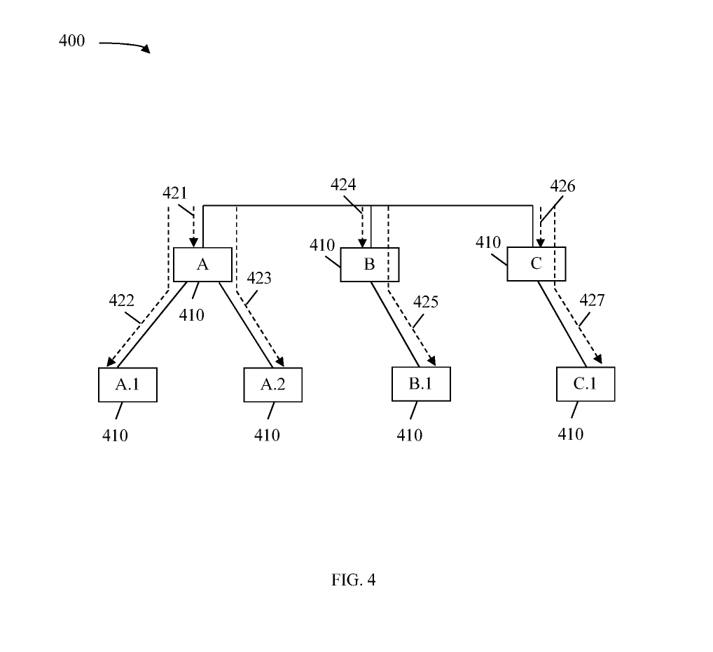

FIG. 4 is a schematic diagram of an embodiment of a file system scanning scheme 400. The scheme 400 is employed by a file server indexing engine, such as the indexing engine 114 in the server 110, to scan all directories 410, such as file system directories 310, in a file system, such as the file system 117, when partitioning the file system into partitions, such as the partitions 330, for the first time (e.g., during an initial crawl). The scheme 400 may be employed in conjunction with the scheme 300. For example, the scheme 400 may be employed to feed the file system directories 310 into the hash function 320 in the scheme 300. As shown, the scheme 400 operates on a file system comprising directories A, B, and C 410. The directory A 410 comprises directories A.1 and A.2 410. The directory B 410 comprises a directory B.1 410. The directory C 410 comprises a directory C.1 410. The scheme 400 scans the directories 410 by employing a depth-first search technique, which scans directories 410 branch by branch until the maximum-depth of a branch is reached. At step 421, the directory A 410 is scanned. At step 422, after scanning the directory A 410, the directory A.1 410 is scanned. At step 423, after scanning the directory A.1 410, the directory A.2 410 is scanned. At step 424, after scanning the directory A.2 410, the directory B 410 is scanned. At step 425, after scanning the directory B 410, the directory B.1 410 is scanned. At step 426, after scanning the directory B.1 410, the directory C 410 is scanned. At step 427, after scanning the directory C 410, the directory C.1 410 is scanned.

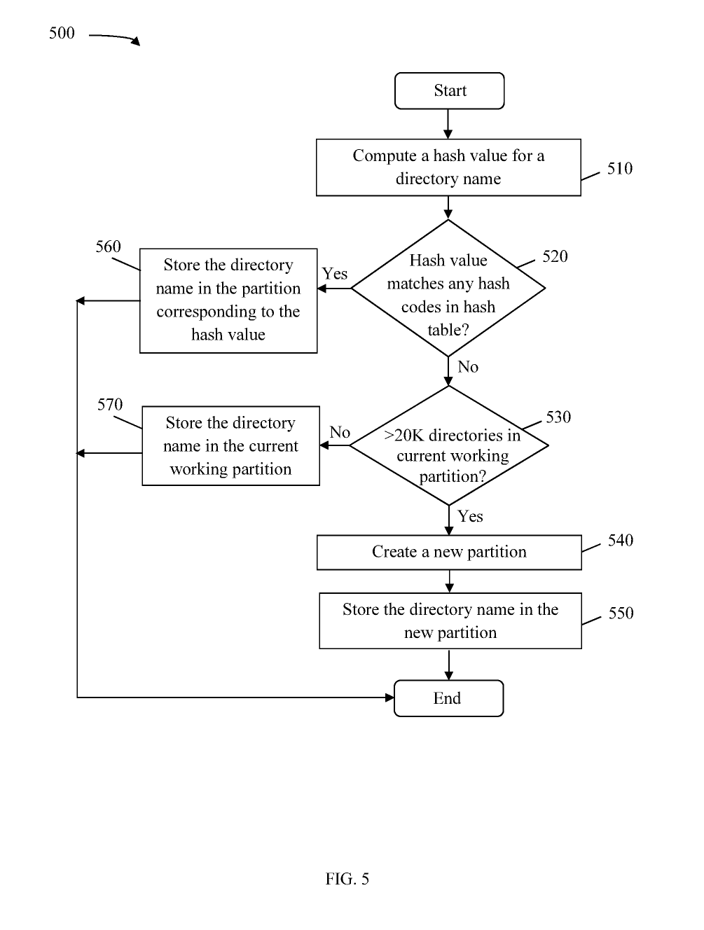

FIG. 5 is a flowchart of an embodiment of a file system partitioning method 500. The method 500 is implemented by a file server indexing engine, such as indexing engine 114 in the server 110 and the NE 200. The method 500 is implemented when creating and/or updating files and/or directories. The method 500 is similar to the scheme 300, where a hashing technique is used to partition a file system, such as the file system 117, by directory names. The method 500 may store the directory names in a hash table, such as the hash table 112, by partitions, such as the partitions 330. For example, the hash table may comprise a plurality of containers indexed by hash codes, where each container may correspond to a partition and may store the directory names corresponding to the partition. At step 510, a hash value is computed for a directory name, for exampling by applying a BuzHash function. At step 520, a determination is made whether a match is found between the computed hash value and the hash codes in the hash table. If a match is found, next at step 560, the directory name is stored in the partition (e.g., container) identified by the matched hash code. For example, an entry may be generated to map the directory name to the matched hash code. Otherwise, the method 500 proceeds to step 530. At step 530, a determination is made whether a current working partition comprises more than 20K directories (e.g., the maximum size of a partition). If the current working partition comprises less than 20K directories, next at step 570, the directory name is stored in the current working partition. For example, an entry may be generated to map the directory name to a hash code of the current working partition. Otherwise the method 500 proceeds to step 540. It should be noted that the maximum partition size may be alternatively configured as determined by a person of ordinary skill in the art to achieve similar functionalities.

At step 540, a new partition is created and indexed under the computed hash value. At step 550, the directory name is stored in the new partition. For example, an entry may be generated to map the directory name to the computed hash value. Thus, when the method 500 is applied to partition a file system for a first time, the first partition is indexed by a hash value dependent on the first scanned directory and subsequent directories may be placed in the same partition until the first partition reaches the maximum partition size. The method 500 may be repeated for a next directory in the file system. As described above, during an initial crawl of the file system, the directories are scanned based on directory names, for example, by employing the scheme 400. Thus, the file system is partitioned by an order of directory names and based on crawl time. Subsequent crawls due to file and/or directory updates are based on change times. Thus, the file system is partitioned by order of change times after the initial partition.

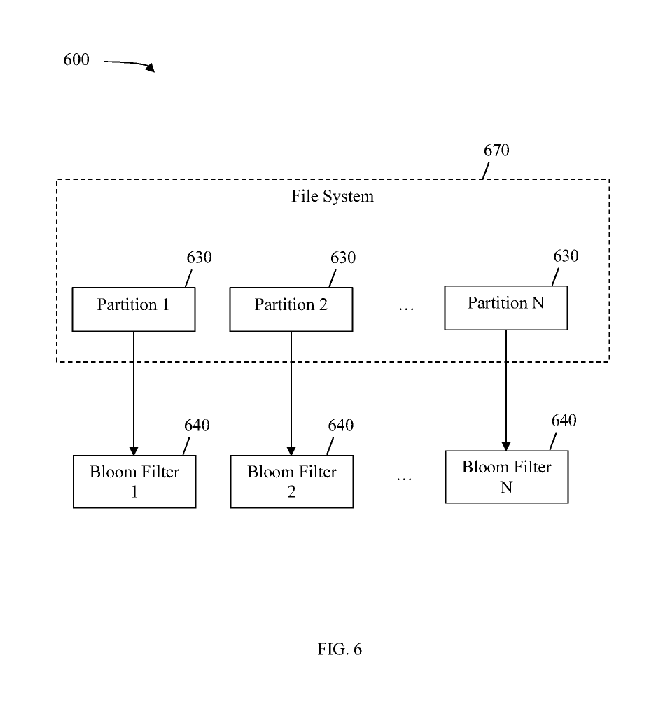

FIG. 6 is a schematic diagram of an embodiment of a bloom filter generation scheme 600. The scheme 600 is employed by a file server search engine, such as the search engine 115 in the server 110. The scheme 600 is implemented after a file system 670, such as the file system 117, is partitioned into multiple partitions 630, such as the partitions 330, for example, by employing similar mechanisms as described in the schemes 300 and 400 and the method 500. The scheme 600 may be employed during an initial partition when files and/or directories are created and/or inserted into the file system and subsequent re-partitions when the file system is changed. For example, the directory names for the partitions 630 are stored in a hash table, such as the hash tables 112 and 340. In the scheme 600, a bloom filter 640, such as the bloom filters 113, is generated for each partition 630. The bloom filters 640 are probabilistic data structures designed to test membership of elements (e.g., directory names) to a set (e.g., in a partition 630). The bloom filters 640 allow for false positive matches, but not false negative matches. Thus, the bloom filters 640 reduce the number of partitions 630 (e.g., by about 90-95%) that are required for a query search. In an embodiment, when the partition 630 comprises about 30K directories, the bloom filters 640 may be configured as bit vectors of about 32K bits long. To generate a bloom filter 640, all the bits in the bloom filter 640 are first initialized to zeroes and the directory names in a corresponding partition 630 are added to the bloom filter 640 to create a set. To add a directory name to the bloom filter 640, the directory name is hashed k times (e.g., with k hashed functions) to generate k bit positions in the bit vector of the bloom filter 640 and the bits are set to ones, where k may be about 4. In one embodiment, each directory name is added to the bloom filter 640 as one element, where the k hash functions are applied to the entire directory name. In some other embodiments, a directory name (e.g., /a/b/c) may be divided into multiple elements (e.g., /a, /b, /c) and each element is added as a separate element in the bloom filter 640, where the k hash functions are applied to each element separately. It should be noted that the bloom filters 640 may be configured with different lengths and/or different number of hash functions depending on the number of directory names in the partitions 630 and a desired probability of false positive matches.

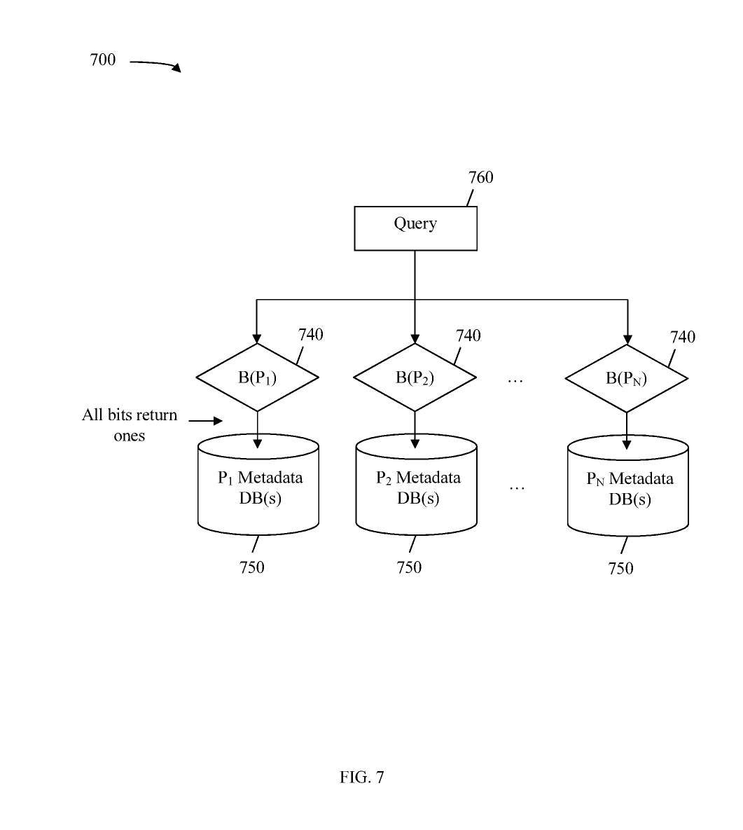

FIG. 7 is a schematic diagram of an embodiment of a metadata index search query scheme 700. The scheme 700 may be employed by a file server search engine, such as the search engine 115 in the server 110. The scheme 700 is implemented when a query 760 for a file system object (e.g., a file or a directory) is received, for example, from a client such as the client 120. For example, a file system, such as the file systems 117 and 670, is partitioned into multiple partitions, such as the partitions 330 and 630, a bloom filter 740, such as the bloom filters 113 and 640, is generated for each partition, and one or more metadata DBs 750, such as the metadata DB 111, are generated for each partition. The file system may be partitioned by employing similar mechanisms as described in the schemes 300 and 400 and the method 500. The bloom filters 740 may be generated by employing similar mechanisms as described in the schemes 600. As described above, the file system may be partitioned based on directory names and the bloom filters 740 may be generated by hashing directory names in corresponding partitions to produce representations (e.g., encoded hashed information) of directory names in the corresponding partitions. For example, the bloom filters B(P₁) to B(P_{N}) 740 are representations of directory names in partition P₁ to P_{N}, respectively, of the file system. In the scheme 700, upon receiving a query 760, the query 760 may be passed through each bloom filter 740 to test whether a corresponding partition may comprise data relevant to the query 760. Since the bloom filters 740 are representations of directory names, the query 760 may comprise at least a portion of a directory name. For example, to search for a file /a/b/c/data.c, the query 760 may include at least a portion of the pathname, such as /a, /a/b, or /a/b/c. The query 760 may additionally include other metadata, such as file base name (e.g., data.c), file type, user ID, a group ID, access time, and/or custom attributes, associated with the file data.c, as discussed more fully below. To test for a match in a particular partition, the query 760 is hashed k times to obtain k bit positions. When the bloom filter 740 returns values of one for all k bits, the particular partition may comprise a possible match for the query 760. When any of the k bits comprises a value of zero, the particular partition definitely does not comprise data relevant to the query 760. As such, further searches in a particular partition may only proceed if the corresponding bloom filter 740 indicates a possible match. For example, when the bloom filter B(P₁) 740 returns a possible match for the query 760, the partition P₁'s metadata DBs 750 are searched. Otherwise, the partition P₁'s metadata DBs 750 are skipped for the search. In an embodiment, a Unix system call strtok( ) may be employed to extract pathnames from keys stored in the metadata DBs 750, where the keys may be similar to the keys shown in Table 1. It should be noted that the bloom filters 740 may be alternatively configured to represent other types of metadata, in which the query 760 may be configured to include at least one element associated with the metadata represented by the bloom filters 740.

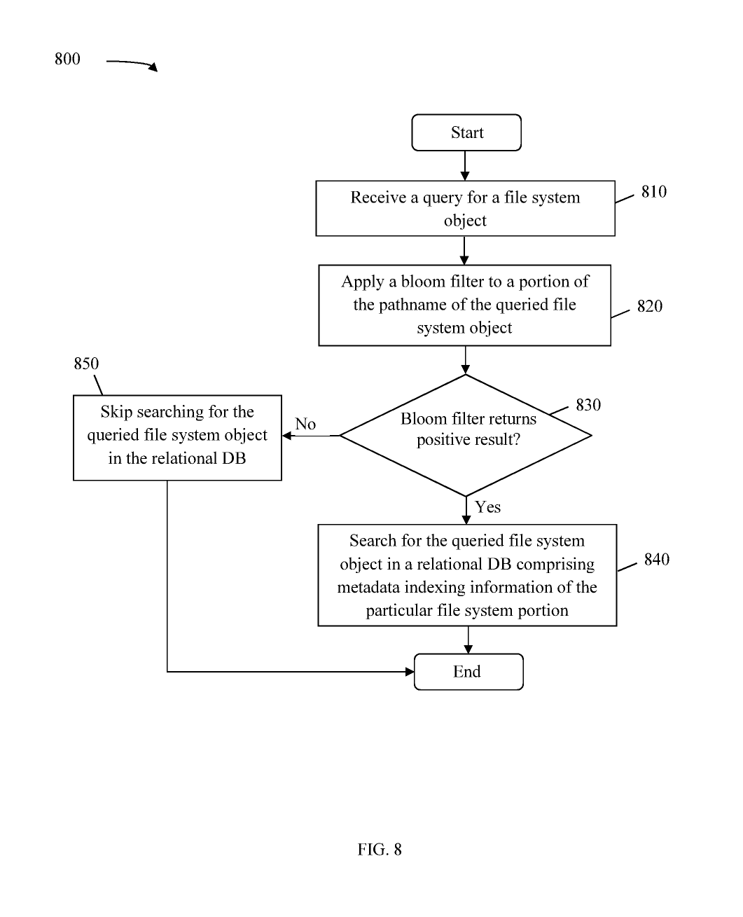

FIG. 8 is a flowchart of an embodiment of a metadata index search query method 800. The method 800 is implemented by a file server search engine, such as the search engine 115 and the NE 200. The method 800 employs similar mechanisms as described in the scheme 700. The method 800 is implemented when searching for a file system object in a large-scale storage file system, such as the file system 117. For example, the file system may be partitioned into a plurality of partitions, such as the partitions 330 and 630, by employing the scheme 300 and the method 500. The method 800 begins at step 810 when a query for a file system object is received, for example, from a client, such as the client 120. The file system object may be a file or a directory. The file system object is identified by a pathname. The query includes at least a portion of the pathname. At step 820, upon receiving the query, a bloom filter is applied to the portion of the pathname of the queried file system object. The bloom filter is similar to the bloom filters 113, 640, and 740. The bloom filter comprises representations of file system object pathnames of a particular portion of the large-scale storage file system, for example, generated by employing the scheme 600. At step 830, a determination is made whether the bloom filter returns a positive result indicating that the queried file system object is potentially mapped to the particular file system portion. In one embodiment, the bloom filter may be generated by adding an entry for each pathname. In such an embodiment, the query comprises a pathname of the queried file system object and the bloom filter is applied to the queried file system object pathname. In another embodiment, the bloom filter may be generated by adding an entry for each component (e.g., /a, /b, and /c) of a pathname (e.g., /a/b/c). In such an embodiment, the queried file system object pathname (e.g., /x/y/z) is divided into a plurality of components (e.g., /x, /y, and/z) and the bloom filter is applied to each pathname component. A positive result corresponds to positive matches for all pathname components. A negative result corresponds to a negative match for any one of the pathname components.

If the bloom filter returns a positive result, next at step 840, a relational DB comprising metadata indexing information of the particular file system portion is searched for the queried file system object. The relational DB may be similar to the metadata DBs 111. For example, the relational DB may comprise a plurality of tables, where each table may store a particular type of metadata associated with file system objects in the particular file system portion. The tables may store metadata in key-value pairs as shown in the Tables 1 and 2 described above. For example, the metadata types may be associated with a base name, a full pathname, a file size, a file type, a file extension, a file access time, a file change time, a file modification time, a group ID, a user ID, a permission, and/or a custom file attribute. In an embodiment, the query may comprise a pathname of the file system object and a metadata of the file system object, where the format of the query are described more fully below. The relational DB may be searched by first locating a device number and an inode number corresponding to the pathname of the queried file system object (e.g., from a PATH table). Subsequently, other tables in the relational DB may be searched by locating entries with the device number and the inode number and determining whether a match is found between the queried metadata and the located entries.

If the bloom filter returns a negative result at step 830 indicating that the queried file system object is not mapped to the particular file system portion, the method 800 proceeds to step 850. At step 850, a search for the queried file system object in the relational DB is skipped. It should be noted that the bloom filter may return a false positive match, but may not return a false negative match. The steps of 820-850 may be repeated for another bloom filter that represents another portion of the file system.

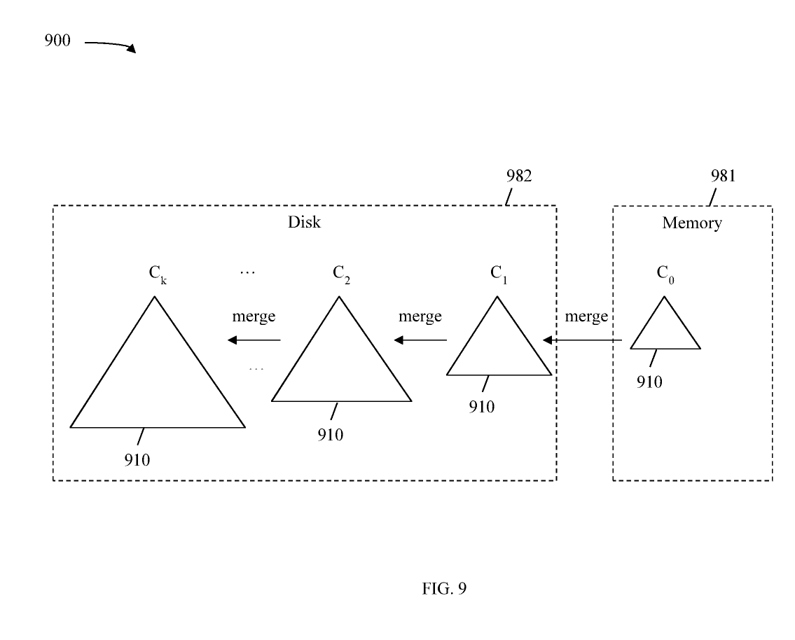

FIG. 9 is a schematic diagram of an embodiment of a metadata DB storage scheme 900. The scheme 900 is employed by a file server indexing engine, such as the indexing engine 114 in the server 110, to implement file system metadata DBs, such as the metadata DBs 117 and 670, for file system indexing. The scheme 900 employs an LSM tree technique to provide efficient indexing updates by deferring updates and updating in batches. In the scheme 900, a metadata dB is composed of two or more tree-like component data structures 910 (e.g., C₀ to Cₖ). The data structures 910 comprise key-value pairs similar to the entries shown in Tables 1 and 2 described above. As shown, a first-level data structure C₀ 910 is stored in local system memory 981, such as the memory device 232, of a file server, such as the file server 110 or the NE 200, where the local system memory may provide fast access. The data structures C₁ to Cₖ 910 in subsequent levels are stored on disk 982, for example, a hard disk drive, which may comprise a slower access speed than the local system memory 981. The data structure C₀ 910 that is resident in the local system memory 981 is usually smaller in size than the data structures C₁ to Cₖ 910 that are stored on the disk 982. In addition, the sizes of the data structures C₁ to Cₖ 910 may increase for each subsequent level. The data structure C₀ 910 is employed for storing metadata that are updated most recently. When the data structure C₀ 910 reaches a certain size or after a certain time, the data structure C₀ 910 is migrated into the disk 982. When the data structure C₀ 910 is migrated into disk 982, the data structure C₀ 910 is merged into a next level data structure C₁ 910 and sorted in the next level data structure C₁ 910. The merge-sort process may be repeated for subsequent levels of data structures C₂ to Cₖ₋₁ 910. Thus, when employing the LSM tree technique to implement metadata DBs, updates are deferred and performed in batches. When a metadata DB is searched, the search may first scan the data structure C₀ 910 resident in the local system memory 981. When no matches are found, the search may continue to a next level data structure 910. Thus, the scheme 900 may also allow for efficient searches. It should be noted that levelDB is a type of database that employs the LSM technique shown in the scheme 900.

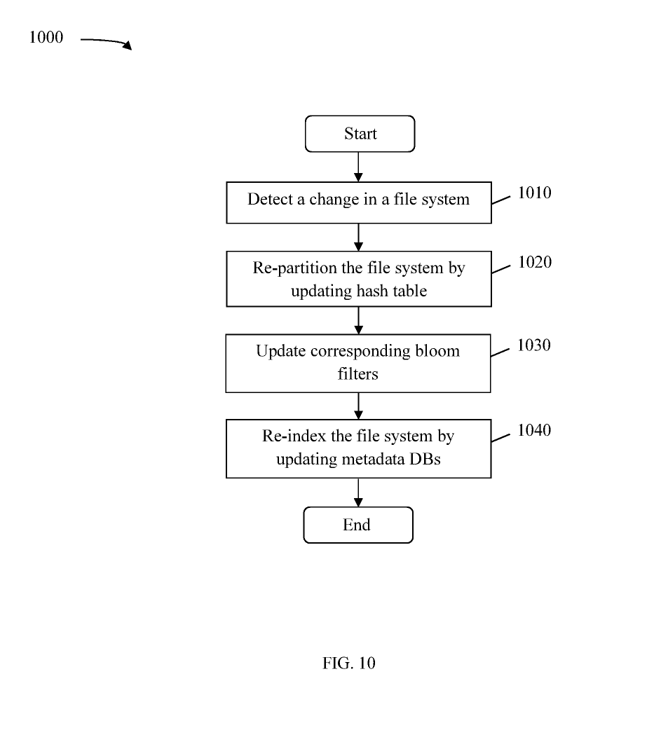

FIG. 10 is a flowchart of an embodiment of a file system metadata update method 1000. The method 1000 is implemented by a file server indexing engine, such as the indexing engine 114 in the server 110 and the NE 200. The method 1000 is implemented after the file server indexing engine has indexed a file system. For example, the file system may be partitioned by directory names via a hashing technique as described in the schemes 300 and 400 and the method 500. The partitions, such as the partitions 330 and 630, may be stored in a hash table, such as the hash tables 112 and 340. In addition, bloom filters, such as the bloom filters 113, 640, and 740, are generated for the partitions, for example, by employing the scheme 600 and the method 800. Further, metadata DBs, such as the metadata DBs 111 and 750, may be generated for the partitions, for example, by employing the scheme 900. The method 1000 begins at step 1010 when a change is detected in a file system, such as the file system 117. The change may be a file or a directory removal, addition, move, or a file update. Some operating systems (e.g., Unix and Linux) may provide an application programming interface (API) or a system call (e.g., inotify( )) for monitoring file system changes. At step 1020, after detecting a file system change, the file system is re-partitioned by updating the hash table, for example, by employing similar mechanisms as shown in the scheme 300 and the method 500. At step 1030, after re-partitioning the file system, one or more corresponding bloom filters are updated, for example, by employing the scheme 600. For example, when a directory is moved, the previous pathname may be removed from a previous partition and the updated pathname may be added to an updated partition. Thus, the bloom filters corresponding to the previous partition and the updated partition may be updated. At step 1040, the file system is re-indexed by updating one or more metadata DBs corresponding to the updated partitions, for example, by employing the scheme 900.

In an embodiment, a client, such as the client 120, may send a query, such as the query 760, to a file server, such as the file server 110, to search for a file system object (e.g., a file or a directory) in a file system, such as the file system 117. A query may be formatted as shown below:
<Variable><relop><constant> & <variable><relop><constant>,
   where the variables may be any types of file system metadata, such as a pathname, a base name, a user ID, a group ID, a file size, a number of links associated with a file, a permission (e.g., 0644 in octal), a file type, a file access time, a file change time, a file modification, and a custom file attribute. The following table summarizes the query variables:

TABLE 3
Examples of Query Variables

| Query Variables | Descriptions |
|---|---|
| base | Base name of a file |
| uid | Numeric user ID |
| gid | Numeric group ID |
| size | File size in bytes |
| links | Number of hard links on a file |
| perm | Permission |
| type | File type |
| atime | Access time |
| ctime | Change time |
| mtime | Modification time |
| path | Path name prefix |

The relop may represent a relational operator, such as greater than (e.g., >), greater than or equal to (e.g., >=), less than (e.g., <), less than or equal to (e.g., <=), equal to (e.g., =), or not equal to (e.g., [symbol] =). It should be noted that when a file server employs bloom filters, such as the bloom filters 113, based on pathnames, the query may comprise at least one variable corresponding to at least a portion of a pathname of a queried file system object. For example, the first variable in a query may be a pathname variable. As such, a prefix search may be employed when performing a metadata index search. The following lists some examples of queries:
path=/proj/a/b/c/ & base=random.c
path=/proj/a/b/c/ & links>1.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. An apparatus comprising:
an input/output (IO) port configured to couple to a large-scale storage device;
a memory configured to store a plurality of metadata databases (DBs) for a file system of the large-scale storage device, wherein the plurality of metadata DBs comprise key-value pairs with empty values; and
a processor coupled to the IO port and the memory, wherein the processor is configured to:
partition the file system into a plurality of partitions by grouping directories in the file system by a temporal order; and
index the file system by storing metadata of different partitions as keys in separate metadata DBs.

2. The apparatus of claim 1, wherein the memory is further configured to store a hash table comprising entries that map the directories to the partitions, wherein the partitions are identified by hash codes, and wherein the processor is further configured to partition the file system by:
computing a hash value for a first of the directories;
determining whether the computed hash value matches the hash codes in the hash table; and
generating a first hash table entry to map the first directory to a partition identified by the matched hash code when a match is found.

3. The apparatus of claim 2, wherein the processor is further configured to partition the file system by:
determining whether a current working partition is full when a match is not found;
generating a second hash table entry to map the first directory to the current working partition when the current working partition is not full; and
generating a third hash table entry to map the first directory to a new partition identified by the computed hash value when the current working partition is full.

4. The apparatus of claim 1, wherein the processor is further configured to partition the file system by scanning the directories by an order of directory pathnames during an initial partition, and wherein the directories are grouped in the temporal order based on directory scan time.

5. The apparatus of claim 1, wherein the processor is further configured to:
detect a file system change associated with one of the directories;
perform file system re-partitioning according to a change time of the detected file system change; and
perform file system re-indexing according to the detected file system change.

6. The apparatus of claim 1, wherein the processor is further configured to generate a bloom filter to represent a portion of the metadata associated with a first of the partitions.

7. The apparatus of claim 6, wherein the portion of the metadata represented by the bloom filter is associated with a directory pathname in the first partition.

8. The apparatus of claim 7, wherein the processor is further configured to generate the bloom filter by:
dividing the directory pathname into a plurality of components; and
adding an entry to the bloom filter for each pathname component.

9. The apparatus of claim 1, wherein a first of the plurality of metadata DBs and a second of the plurality of metadata DBs are related by comprising different metadata associated with a same file system object in the file system, and wherein the file system object corresponds to a first of the directories, a file under the first directory, or combinations thereof.

10. The apparatus of claim 1, wherein a first of the plurality of metadata DBs comprises a first of the keys comprising a device number, an index node (inode) number, and a first of the metadata, wherein the device number identifies the file system, wherein the inode number identifies a file system object in the file system, and wherein the first metadata comprises a file system attribute of the file system object, a number of links associated with the file system object, an inverted relationship between the file system object and the links, a custom attribute of the file system object, or combinations thereof.

11. The apparatus of claim 1, wherein the memory is further configured to store a main DB for a first of the partitions, wherein the main DB comprises a main key and a main value, wherein the main key comprises a combination of a device number and an index node (inode) number that identifies a file system object in the first partition, and wherein the main value comprises different types of metadata associated with the file system object.

12. An apparatus comprising:
an input/output (IO) port configured to couple to a large-scale storage device;
a memory configured to store:
a relational database (DB) comprising metadata indexing information of a portion of a file system of the large-scale storage device; and
a bloom filter comprising representations of at least a portion of the metadata indexing information; and
a processor coupled to the IO port and the memory, wherein the processor is configured to:
receive a query for a file system object; and
apply the bloom filter to the query to determine whether to search the relational DB for the queried file system object.

13. The apparatus of claim 12, wherein the query comprises at least a portion of a pathname of the queried file system object.

14. The apparatus of claim 13, wherein the bloom filter is applied to the portion of the pathname in the query, and wherein the processor is further configured to:
search the relational DB for the queried file system object when the bloom filter returns a positive match for the portion of the pathname; and
skip searching the relational DB for the queried file system object when the bloom filter returns a negative match for the portion of the pathname.

15. The apparatus of claim 13, wherein the processor is further configured to apply the bloom filter to the query to determine whether to search the relational DB for the queried file system object by:
dividing the portion of the file system object pathname into a plurality of components;
applying the bloom filter to each pathname component separately;
searching the relational DB based on the query when the bloom filter returns positive results for all pathname components; and
skipping search the relational DB for the queried file system object when the bloom filter returns a negative result for one of the components.

16. The apparatus of claim 12, wherein the relational DB comprises a plurality of tables comprising key-value pairs with empty values, and wherein a first of the key-value pairs comprises a key comprising:
a combination of a device number and an index node (inode) number identifying a file system object stored in the portion of the file system; and
a metadata of the stored file system object in the portion of the file system.

17. The apparatus of claim 16, wherein the metadata of the stored file system object comprises a file system attribute of the stored file system object, a number of links corresponding to the stored file system object, an inverted relationship between the stored file system object and the links, or a custom attribute of the stored file system object.

18. A method for searching a large-scale storage file system, comprising:
receiving a query for a file system object, wherein the query comprises at least a portion of a pathname of the queried file system object;
applying a bloom filter to the portion of the pathname of the queried file system object, wherein the bloom filter comprises representations of pathnames in a particular portion of the large-scale storage file system;
searching for the queried file system object in a relational database (DB) comprising metadata indexing information of the particular file system portion when the bloom filter returns a positive result; and
skipping search for the queried file system object in the relational DB when the bloom filter returns a negative result.

19. The method of claim 18, wherein the query comprises a pathname of the queried file system object, wherein the bloom filter comprises representations of file object pathnames in the particular file system portion, wherein applying the bloom filter to the query comprises:
dividing the pathname of the queried file system object into a plurality of components; and
applying the bloom filter to each pathname component separately to determine a membership for the pathname component,
wherein the file system object is determined to be mapped to the particular file system portion when the bloom filter returns positive memberships for all the pathname components, and
wherein the file system object is determined to be not mapped to the particular file system portion when the bloom filter returns a negative membership for one of the pathname components.

20. The method of claim 18, wherein the relational DB is a levelDB comprising a plurality of multi-level Log-Structured Merge (LSM) tree data structures that store the metadata indexing information.
